(19) United States
(12) Patent Application Publication
(10) Pub. No.: US 2013/0159972 A1
(43) Pub. Date: Jun. 20, 2013

(54) IDENTIFYING COMPONENTS OF A BUNDLED SOFTWARE PRODUCT

(71) Applicant: INTERNATIONAL BUSINESS MACHINES CORPORATION, Armonk, NY (US)

(72) Inventors: Remigiusz Dudek, Rybnik (PL); Pawel Gocek, Lodz (PL); Jakub Kania, Bielsko-Biala (PL); Hari H. Madduri, Austin, TX (US)

(73) Assignee: INTERNATIONAL BUSINESS MACHINES CORPORATION, Armonk, NY (US)

(21) Appl. No.: 13/766,721

(22) Filed: Feb. 13, 2013

Related U.S. Application Data
(63) Continuation of application No. 13/455,997, filed on Apr. 25, 2012.

(30) Foreign Application Priority Data
Aug. 25, 2011 (EP) 11178870.9

(51) Int. Cl. G06F 9/44

(52) U.S. Cl. CPC G06F 8/70
USPC 717/120

(57) ABSTRACT

A method for identifying software components of a software product comprises establishing, by a computer, data representative of at least one of an attribute and an action of at least one of a first software component in a computer system and a second software component in the computer system, establishing a first confidence value indicative of a likelihood that the first software component belongs to the software product, establishing, based on the data, a second confidence value indicative of a likelihood that the first software component and the second software component are software components of a common software product, and establishing, based on the first and second confidence values, a third confidence value indicative of a likelihood that the second software component belongs to the software product.

### BACKGROUND

The present disclosure is an invention disclosure relating to identifying components of a software product, e.g. a bundled software product, and more specifically, to a method for identifying software components of a software product, to a system for identifying software components of a software product and to a corresponding computer program product.

A software bundle is a collection of software components that is licensed or sold together, sometimes even in a common package, to serve a particular business need. For example, an enterprise software bundle may comprise an application server, a database, an administration console component and reporting components.

Software entities that may constitute components of a software bundle, e.g. an application server or database used to deploy a customer's applications, may be purchasable as standalone software products. Similarly, software entities may be purchased as part of a software bundle for limited use with other components belonging to the same bundle. For example, the application server or database that may be sold as a standalone software product may likewise be sold as a software component of a bundled software product, i.e. for providing more complex functionality through cooperation with the other software components of the bundled software product.

The price of a software entity may depend on whether that software entity is sold/licensed as a standalone product or sold/licensed as a component of a bundle. In some cases, a fee may be charged for use of a software entity when used as a standalone product, whereas use of the same software entity as a component of a bundle may be free of charge.

### BRIEF SUMMARY

A method and technique for identifying software components of a software product comprises establishing, by a computer, data representative of at least one of an attribute and an action of at least one of a first software component in a computer system and a second software component in the computer system, establishing a first confidence value indicative of a likelihood that the first software component belongs to the software product, establishing, based on the data, a second confidence value indicative of a likelihood that the first software component and the second software component are software components of a common software product, and establishing, based on the first and second confidence values, a third confidence value indicative of a likelihood that the second software component belongs to the software product.

### BRIEF DESCRIPTION OF THE SEVERAL VIEWS OF THE DRAWINGS

FIG. 1 schematically shows an embodiment of a system for identifying software components of a software product in accordance with the present disclosure; and

FIG. 2 shows a flowchart of an embodiment of a method for identifying software components of a software product in accordance with the present disclosure.

### DETAILED DESCRIPTION

The present disclosure teaches techniques for identifying software components of a software product. Based on a likelihood that a first software entity constitutes a component of the software product and a likelihood that both a second software entity and the first software entity are components of a common software product, an (indirect) assessment is made as to whether the second software entity constitutes a component of the software product. This indirect assessment can be complemented by a direct assessment as to whether the second software entity constitutes a component of the software product.

In one aspect, the present disclosure relates to a method for identifying software components of a software product, e.g. identifying individual software entities constituting software components of a bundled software product.

The method may comprise establishing, by a computer, data representative of at least one of an attribute and an action of at least one of a first software component in a computer system and a second software component in the computer system.

In the context of the present disclosure, a computer system may be understood as a computing environment configured to be accessible only to a single user. For example, such a computing environment may be a laptop computer, a personal computer, a user account on a personal computer or a user account in a computer network. In the context of the present disclosure, a computer system may also be understood as a computing environment operated by a single legal entity, e.g. a corporation, institute, government agency, etc. Such a computing environment may include a plurality of networked computers, servers, etc. The computing environment may be accessible solely to employees/members of the legal entity. The computing environment may furthermore be accessible to third parties, i.e. to persons that are not employees/members of the legal entity. The legal entity, as the operator of the computing environment, may bear the legal responsibility for purchase/licensing of some or all software employed within the computing environment. The boundary of the computing environment may be defined by one or more boundaries where legal responsibility for purchase/licensing of some or all software employed within the computing environment would shift to another legal entity. The boundary of the computing environment may be the property boundaries of the legal entity's place(s) of business. The property boundaries may be understood as encompassing mobile devices used by employees/members of the legal entity at a location remote from the legal entity's premises. In the case of outsourced services, for example, a contract between the legal entity and a service provider may stipulate that legal responsibility for purchase/licensing of some or all software employed within the computing environment may be incumbent upon the legal entity, although part or all of the computing environment is operated by one or more service providers not necessarily affiliated with the legal entity.

In the context of the present disclosure, a software component (also referred to as a software entity) may be understood as a quantity of code capable of self-contained execution, i.e. that can be executed without requiring code other than that provided by the operating system of the host computer/server. A software component may be an application.

The aforementioned data may comprise data indicative of at least one of a location of a first software component in a computer system and a location of a second software component in the computer system, the location of a software component being an attribute thereof. Accordingly, the method may comprise establishing data indicative of at least one of a location of a first software component in a computer system and a location of a second software component in the computer system.

In the context of the present disclosure, the location of the first/second software component may be understood as a path name identifying a path to the respective software component or to a folder in which the respective software is stored. The path name may be relative to a boot volume of the computer/server/network on which the respective software component is stored or relative to a user's home folder, for example. The location of the first/second software component may likewise be understood as a computer, server or folder on which/in which the respective software component is stored. The computer/server may be uniquely identified, e.g. within a local area network, by an IP address, a MAC address, a serial number associated with the computer/server, a network identifier associated with the computer/server, a “fingerprint” derived e.g. from a configuration log or other machine-specific information, etc. Collocation of the first and second software components or similarities in the respective locations of the first and second software components, e.g. collocation on a common host (computer/server) or collocation within a common folder or location within nested folders, can be indicative of the two software components being related, i.e. belonging to a common software product.

The aforementioned data may comprise data indicative of an occurrence of communication between a first and a second software component in a computer system, communication by a software component being an action thereof. Accordingly, the method may comprise establishing data indicative of an occurrence of communication between a first and a second software component in a computer system. The communication may be direct or indirect communication. The first software component may communicate data to the second software component that then undergoes further processing by the second software component, or vice versa. The further processed data may be communicated from the second software component to the first software component, or vice versa. In other words, the first and second software components may communicate data in one or two directions to obtain results that the first/second software component could not achieve individually. Communication between the first and second software components can be indicative of the two software components being related, i.e. belonging to a common software product.

The aforementioned data may comprise data indicative of a configuration reference in a computer system between a first software component and a second software component, a configuration reference with regard to a software component being a (configuration) attribute thereof. Accordingly, the method may comprise establishing data indicative of a configuration reference in a computer system between a first software component and a second software component. For example, the first software component may be associated with configuration data that may have been automatically generated upon installation of the first software component or the second software component, which configuration data contains a pointer or other identifier specifying the existence/location of the second software component. Similarly, the first software component may be associated with configuration data provided by a user, which configuration data likewise contains a pointer or other identifier specifying the existence/location of the second software component. Similarly, the second software component may be associated with configuration data that specifies the existence/location of the first software component. The existence of configuration references between the first and second software components can be indicative of the two software components being related, i.e. belonging to a common software product.

The aforementioned data may comprise data indicative of an installation time of a first software component in a computer system and an installation time of a second software component in the computer system, the installation time of a software component being an attribute thereof. Accordingly, the method may comprise establishing data indicative of an installation time of a first software component in a computer system and an installation time of a second software component in the computer system. Installation of the first and second software components at roughly the same time, e.g. within a period of one week, one day, one hour or ten minutes, can be indicative of the two software components being related, i.e. belonging to a common software product.

The method may comprise establishing a first confidence value indicative of a likelihood that a first software component belongs to a software product. The first confidence value may be a normalized value, e.g. a percentage between 0% and 100%, 0% being indicative of zero likelihood that the first software component belongs to the software product and 100% being indicative of full certainty that the first software component belongs to the software product. Percentages between 0% and 100% may be indicative of corresponding linear ratios of certainty. For example, a value of 50% may indicate half certainty, i.e. a 50/50 chance (also known as a one in two chance) that the first software component belongs to the software product.

The method may comprise establishing data indicative of whether a relationship between the first software component and the second software component is defined in a catalog. For example, the catalog may comprise a list of part numbers and/or component names, each part number/component name designating a respective software component. Individual software products may be associated with at least one such list of part numbers and/or component names. The software components designated by the at least one list may constitute a respective (bundled) software product. Thus, an appearance of references to both the first software component and the second software component in any such list can be indicative of the two software components being related, i.e. belonging to a common software product.

The method may comprise establishing, based on any of the aforementioned data, a second confidence value indicative of a likelihood that the first software component and the second software component are software components of a common software product. The common software product need not be the software product mentioned with regard to the first confidence value. As such, the second confidence value can be simply indicative of a likelihood that the first software component and the second software component are software components of a common software product at all. Like the first confidence value, the second confidence value may be a normalized value, e.g. a percentage as discussed above.

The method may comprise establishing, based on the first and second confidence values, a third confidence value indicative of a likelihood that the second software component belongs to the software product. As such, the third confidence value, i.e. a likelihood that the second software component belongs to the software product, need not be established based on the apparent relationship directly between the second software component and the software product. Instead, the third confidence value, i.e. a likelihood that the second software component belongs to the software product, may be established indirectly, i.e. based on a likelihood that the first software component belongs to a software product and a likelihood that the first and second software component both belong to any common software product, i.e. based on an apparent relationship between the first software component and the second software component. Like the first confidence value, the third confidence value may be a normalized value, e.g. a percentage as discussed above.

The method may comprise establishing, for the second software component, a fourth confidence value indicative of a likelihood that the second software component belongs to the software product. Like the first confidence value, the fourth confidence value may be a normalized value, e.g. a percentage as discussed above.

Any of the first, second, third and fourth confidence values may be initially set to a value of 0%.

The establishing of the third confidence value may be effected based on the first, second and fourth confidence values. Thus, the third confidence value, i.e. a likelihood that the second software component belongs to the software product, may be established not only indirectly, i.e. on a likelihood that the first software component belongs to the software product and a likelihood that the first and second software component both belong to a common software product, but also directly, i.e. on a likelihood that the second software component belongs to the software product, i.e. to the same software product as the first software component.

The establishing of the fourth confidence value may comprise establishing whether the second software component belongs to a predetermined catalog set of software components associated with the software product. The predetermined catalog set may be a list of part numbers and/or component names, each part number/component name designating a respective software component. Each of a plurality of software products may be associated with at least one such list of part numbers and/or component names. The software components designated by the at least one list may constitute the respective (bundled) software product. A specific software entity may constitute a component of various software products. Moreover, a specific software entity may constitute a standalone application. Thus, a catalog relationship between a software entity and a software product need not be indicative of full confidence that the software entity is a component of the software product. The fourth confidence value may be increased by a percentage obtained by dividing one hundred percent by the number of different software products for which the second software component is known to constitute a possible component. For example, if a given software entity is known to be employable as a component for four different software products, then the confidence value would be 25%.

The establishing of the fourth confidence value may comprise establishing whether a product number associated with the second software component comprises a part number component indicative of a bundling of the first software component to the software product. The second software component may comprise data representative of a product number associated with the second software component. The second software component may comprise an identifier that allows a product number associated with the second software component to be found in a database of product numbers. If a product number associated with the second software component comprises a part number component indicative of a bundling of the first software component to the software product, the fourth confidence value may be increased by a value indicative of partial confidence, e.g. medium confidence, that the first software component constitutes a component of the software product, i.e. that the first software component is bundled to the software product.

The medium confidence mentioned in the previous paragraph may fall in the range of 30 to 90 percent, 40 to 80 percent or 50 to 70 percent confidence that the first software component constitutes a component of the software product. For example, the medium confidence may be 70 percent confidence that the first software component constitutes a component of the software product.

The establishing of the first confidence value may comprise establishing whether the first software component belongs to a predetermined catalog set of software components associated with the software product. The establishing of the first confidence value may comprise establishing whether a product number associated with the first software component comprises a part number component indicative of a bundling of the first software component to the software product. The remarks of the preceding three paragraphs apply mutatis mutandis.

The establishing of the second confidence value may comprise increasing the second confidence value by a value indicative of high confidence that the first software component and the second software component are software components of a common software product if any of the aforementioned data is indicative of an occurrence of communication in the computer system between the first and second software components. The high confidence may be full confidence, i.e. 100 percent confidence that the first software component and the second software component are software components of a common software product, or a confidence of higher than 90 percent or higher than 95 percent that the first software component and the second software component are software components of a common software product.

The establishing of the second confidence value may comprise increasing the second confidence value by a value indicative of high confidence, e.g. as defined above, that the first software component and the second software component are software components of a common software product if any of the aforementioned data is indicative of a configuration reference in the computer system between the first and second software components.

The establishing of the second confidence value may comprise increasing the second confidence value by a value indicative of partial confidence, e.g. medium confidence as defined above, that the first software component and the second software component are software components of a common software product if both the first software component and the second software component belong to a predetermined catalog set of software components associated with a common software product.

The medium confidence mentioned in the previous paragraph may fall in the range of 30 to 90 percent, 40 to 80 percent or 50 to 70 percent confidence that the first software component and the second software component are software components of a common software product. For example, the medium confidence may be 70 percent confidence that the first software component and the second software component are software components of a common software product.

The predetermined catalog set may be a list of part numbers and/or component names, each part number/component name designating a respective software component. Each of a plurality of software products may be associated with at least one such list of part numbers and/or component names. The software components designated by the at least one list may constitute the respective (bundled) software product. A specific software entity may constitute a component of various software products. Moreover, a specific software entity may constitute a standalone application. Thus, a catalog relationship between a software entity and a software product need not be indicative of full confidence that the software entity is a component of the software product.

The establishing of the second confidence value may comprise increasing the second confidence value by a value indicative of partial confidence, e.g. low confidence, that the first software component and the second software component are software components of a common software product if any of the aforementioned data is indicative of the first and second software components being located on a common host. The aforementioned low confidence may fall in the range of 0 to 30 percent, 5 to 25 percent or 10 to 20 percent confidence that the first software component and the second software component are software components of a common software product. For example, the low confidence may be 10 percent confidence that the first software component and the second software component are software components of a common software product.

The establishing of the second confidence value may comprise increasing the second confidence value by a value indicative of partial confidence, e.g. low confidence as defined above, that the first software component and the second software component are software components of a common software product if any of the aforementioned data is indicative of installation paths of the first and second software components being nested.

The establishing of the second confidence value may comprise increasing the second confidence value by a value indicative of partial confidence, e.g. low confidence as defined above, that the first software component and the second software component are software components of a common software product if the data is indicative of the first and second software components having installation times falling within a predetermined period, i.e. that are less than a predetermined period from one another. The predetermined period may be one week, one day, one hour or ten minutes.

The establishing of the third confidence value may comprise multiplying the first and second confidence values. The third confidence value may be a product of the first confidence value and the second confidence value.

As reflected in the specific embodiments discussed supra, the establishing of the first/fourth confidence value may comprise increasing the first/fourth confidence value in accordance with an empirical product bundling rule, the empirical product bundling rule establishing a confidence value that reflects a likelihood that a (given) software component, under given circumstances, is a software components of a (given) software product. The increasing of the first/fourth confidence value can be repeated for a plurality of empirical product bundling rules. Accordingly, the method may comprise providing and/or receiving a plurality of empirical product bundling rules.

As reflected in the specific embodiments discussed supra, the establishing of the second confidence value may comprise increasing the second confidence value in accordance with an empirical component bundling rule, the empirical component bundling rule establishing a confidence value that reflects a likelihood that a first software component and a second software component, under given circumstances, are software components of a common software product. The increasing of the second confidence value can be repeated for a plurality of empirical component bundling rules. Accordingly, the method may comprise providing and/or receiving a plurality of empirical component bundling rules.

The above discussion speaks of increasing a respective confidence value in accordance with an empirical component/product bundling rule. More specifically, the above discussion speaks of increasing a respective confidence value by a value indicative of high, medium and low confidence. The above discussion also mentions exemplary percentages corresponding to the terms high, medium and low confidence. In the context of the present disclosure, the expression “increasing a . . . confidence value by a value indicative of [a particular percentage of] confidence” may be understood as increasing the prior confidence value by the given percentage of the remaining uncertainty. If, for instance, there were already a 70% likelihood that the respective condition is fulfilled and the confidence value were to be increased by 50%, then 50% of the remaining 30% uncertainty would be added to the 70% likelihood. The resultant likelihood would be 85%. In this manner, 100% likelihood, i.e. absolute certainty, can be reached, but not exceeded, even if a respective confidence value is repeatedly increased in accordance with each of a plurality of empirical component/product bundling rules.

The method may comprise outputting a determination that the second software component is bundled to, i.e. is a software component of, the software product if the third confidence value exceeds a predetermined threshold value.

The method may comprise establishing a first and third confidence value and, optionally, a fourth confidence value in any manner disclosed in the present disclosure with respect to any of a plurality of software products and may moreover comprise outputting a determination that the second software component is bundled to a given software product if the third confidence value with respect to the given software product is larger than the third confidence value with respect to any other software product. The method may comprise inhibiting the outputting of a determination that the second software component is bundled to the given software product if the third confidence with respect to the given software product value does not exceed a predetermined threshold value.

The method may comprise establishing a first, a second, a third and, optionally, a fourth confidence value in any manner disclosed in the present disclosure with respect to any of a plurality of software entities relative to any of a plurality of software products. The teachings of the preceding two paragraphs apply mutatis mutandis.

Any establishing as discussed hereinabove may be carried out automatically, e.g. without user interaction or with limited user interaction.

While the teachings of the present disclosure have been discussed hereinabove in the form of a method, the teachings may be embodied, mutatis mutandis, in the form of a system or computer program product, as will be appreciated by the person skilled in the art.

A system for identifying software components of a software product may comprise a data establisher that establishes data as discussed hereinabove. The data establisher may be embodied in the form of a single unit comprising hardware and/or software or in the form of a system comprising multiple hardware/software units.

Furthermore, a system for identifying software components of a software product may comprise any of a first confidence value establisher, a second confidence value establisher, a third confidence value establisher and a fourth confidence value establisher for respectively establishing a first/second/third/fourth confidence value as discussed hereinabove. The individual first/second/third/fourth confidence value establishers or any group thereof may be embodied in the form of a single unit comprising hardware and/or software or in the form of a system comprising multiple hardware/software units.

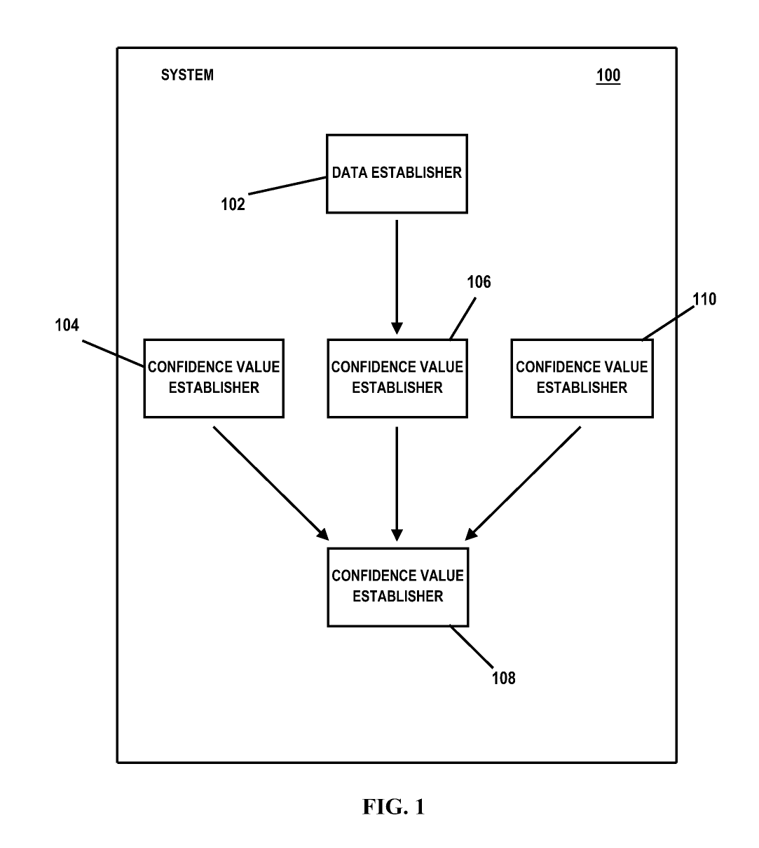

Referring now to the figures, FIG. 1 shows an embodiment of a system 100 for identifying software components of a software product models in accordance with the present disclosure, e.g. as described above.

In the illustrated embodiment, system 100 comprises a data establisher 102 that establishes data, a first confidence value establisher 104 that establishes a first confidence value, a second confidence value establisher 106 that establishes a second confidence value, a third confidence value establisher 108 that establishes a third confidence value, and a fourth confidence value establisher 110 that establishes a fourth confidence value. Data established by data establisher 102 is communicated to second confidence value establisher 106. The first, second and fourth confidence values established by first, second and fourth confidence value establishers 104, 106 and 110, respectively, are communicated to third confidence value establisher 108.

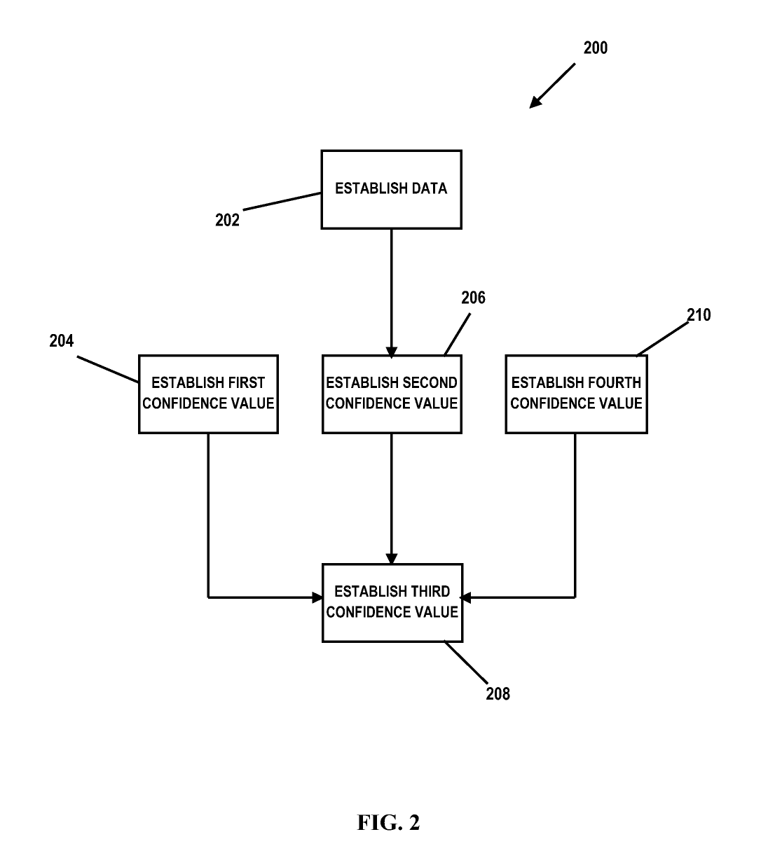

FIG. 2 shows a flowchart 200 of an embodiment of a method for identifying software components of a software product in accordance with the present disclosure, e.g. as described above.

In the illustrated embodiment, flowchart 200 comprises a data establishing 202, an establishing of a first confidence value 204, an establishing of a second confidence value 206, an establishing of a third confidence value 208 and an establishing of a fourth confidence value 210.

In the following, another exemplary embodiment of a method for identifying software components of a software product in accordance with the present disclosure will be described.

The method can provide automatic bundling detection using a 3-pass algorithm having the following steps:
1. Assign possible target products for component instances;
2. Detect component instance relationships; and
3. Propagate product assignment to related component instances (constraint propagation).

In step 1 and 2, a set of rules is applied to calculate bundling probability. Each rule can have a score in a range of (0, 100>. A rule associated with a score of 100 would be a determinant rule. Scores from all applied rules are summed up and normalized, e.g. using the formula:

Cₙ₊₁=Cₙ+(1−Cₙ)*Sₙ/100

where Cₙ is the confidence calculated by applying the n^{th} rule, C₀ having a value of 0; and Sₙ, is the score of the n^{th} rule.

The final confidence is always between 0 and 1. This allows unambiguous comparison of bundling results.

The aforementioned three steps are described in further detail hereinbelow. In step 1, the following product bundling rules are applied for each instance in an enterprise infrastructure.
a. Bundle with all the target products defined in a software catalog with a score of 100/number_of_possible_products (the software catalog defining possible product bundles, i.e. products and components that make up the respective product).
b. Bundle with all the products for customer purchased part numbers with a score of 70 (part numbers being customer entitlements for specific products and defining what software has been purchased by the customer. This rule assumes that the product will be installed with high probability).

After step 1, each instance has 1-n possible target products (bundles). Additional steps limit these possibilities.

In step 2, instance bundling rules (that tell if two instances of components exist in the same bundle) are applied for each pair of component instances installed in the infrastructure.
a. If communication is discovered between component instance processes, then bundle with a score of 100.
b. If a configuration reference is discovered (e.g. if an application server configuration contains a data source definition pointing to a specific database instance), then bundle with a score of 100.
c. If a relationship between component instances is defined in a software catalog, then bundle with a score of 70.
d. If component instances are on the same host, then bundle with a score of 10.
e. If installation paths of the software components are nested, then bundle with a score of 10.
f. If installation times are similar, then bundle with a score of 10.

Upon completion of step 2, a net of component instance relationships, each having a particular confidence score will have been obtained.

In step 3, information gathered in steps 1 and 2 is merged. For each component instance, possible product bundling is calculated using the formula:

C_{C2P1}=C_{C2C1}*C_{C1P1}

where C_{C2P1} is the confidence of bundling component instance C2 with product P1; C_{C2C1} is the confidence of bundling component instance C2 with component instance C1; C_{C1P1} is the confidence of bundling component instance C1 with product P1; C2 is the component being analyzed; C1 is one of the component instances bundled with C2; and P1 is one of the products bundled with the component instance C1.

The above is repeated for every product assigned to C1. Confidence is added and normalized using the same formula as above. This way, product assignment is propagated through a net of bundles.

Upon completion of step 3, component instances will be bundled with target products with a specified confidence level, enhanced by information propagated from other component instances.

In the following, yet another exemplary embodiment of a method for identifying software components of a software product in accordance with the present disclosure will be described.

For the sake of discussion, it is presumed that the following components are found to be installed on a given machine and that each of the components is part of the same bundle, namely Product_1:

Component_1

Component_2

Component_3

The following will demonstrate how the aforementioned 3-pass algorithm can be applied to determine that the aforementioned three components belong to Product_1.

In step 1a of the aforementioned 3-pass algorithm, each instance, i.e. component, is scored using a first rule based on a software catalog. Presuming that the catalog indicates that Component_1 could be bundled with either of two possible products, the Component_2 could be bundled with any of one hundred possible products and that Component_3 could be bundled with any of three possible products, the resulting scores would be as follow:

Component_1:

Comp1_{—}Prod1=0.5

Comp1_{—}Prod2=0.5

Component_2:

Comp2_{—}Prod1=0.01

Comp2_{—}Prod2=0.01

Comp2_{—}Prod3=0.01

Comp2_{—}Prod4=0.01

. . .

Comp2_{—}Prod100=0.01

Component_3:

Comp3_{—}Prod1=0.33

Comp3_{—}Prod2=0.33

Comp3_{—}Prod3=0.33

In step 1b of the aforementioned 3-pass algorithm, each component is scored using a second rule based on part numbers. Presuming that the part number of Component_1 indicates a relationship with Product_1, that the part number of Component_2 indicates a relationship with both Product_1 and Product_3 and that the part number of Component_3 indicates a relationship with Product_1, the resulting scores would be as follow:

Component_1:

Comp1_{—}Prod1=0.7

Comp1_{—}Prod2=0

Component_2:

Comp2_{—}Prod1=0.35(score of 70/2 since two product relationships exist)

Comp2_{—}Prod2=0

Comp2_{—}Prod3=0.35(score of 70/2 since two product relationships exist)

Comp2_{—}Prod4=0

. . .

Comp2_{—}Prod100=0

Component_3:

Comp3_{—}Prod1=0.7

Comp3_{—}Prod2=0

Comp3_{—}Prod3=0

Now the scores obtained using the first and second rule can be summed up and normalized using the aforementioned formula:

Cₙ₊₁=Cₙ+(1−Cₙ)*Sₙ/100

The confidence values obtained after step 1 of the aforementioned 3-pass algorithm are as follow:

Component_1:

Comp1_{—}Prod1=0.5+(1−0.5)*0.7=0.85

Comp1_{—}Prod2=0.5

Component_2:

Comp2_{—}Prod1=0.01+(1−0.01)*0.35=0.3565

Comp2_{—}Prod2=0.01

Comp2_{—}Prod3=0.01+(1−0.01)*0.35=0.3565

Comp2_{—}Prod4=0.01

. . .

Comp2_{—}Prod100=0.01

Component_3:

Comp3_{—}Prod1=0.33+(1−0.33)*0.7=0.799

Comp3_{—}Prod2=0.33

Comp3_{—}Prod3=0.33

Upon completion of step 1, it is uncertain whether Component_2 belongs to Product_1 or Product_3. The further steps of the 3-pass algorithm dispel this uncertainty.

In step 2 of the 3-pass algorithm, the relationship between each pair of components is scored using various bundling rules. Presuming that the co-location of the three components on a single machine/host (rule 2d) is their sole relationship, the resulting scores would be as follow:

Comp1_{—}Comp2=Comp2_{—}Comp1=0.1

Comp1_{—}Comp3=Comp3_{—}Comp1=0.1

Comp2_{—}Comp3=Comp3_{—}Comp2=0.1

Merging the results of steps 1 and 2 as prescribed by step 3 of the 3-pass algorithm to better assess the relationship of Component_2 to the various products yields the following results:

Via Component_1:

Comp2_{—}Prod1=Comp2_{—}Comp1*Comp1_{—}Prod1=0.85*0.1=0.085

Comp2_{—}Prod2=Comp2_{—}Comp1*Comp1_{—}Prod2=0.5*0.1=0.05

Via Component_3:

Comp2_{—}Prod1=Comp2_{—}Comp3*Comp3_{—}Prod1=0.33*0.1=0.033

Comp2_{—}Prod2=Comp2_{—}Comp3*Comp3_{—}Prod2=0.33*0.1=0.033

Comp2_{—}Prod3=Comp2_{—}Comp3*Comp3_{—}Prod3=0.33*0.1=0.033

These confidence values can now be summed with the results obtained in step 1 for Component_2 and normalized. First the additional confidence obtained via Component_1 will be summed and normalized.

Comp2_{—}Prod1=0.3565+(1−0.3565)*0.085=0.4112

Comp2_{—}Prod2=0.01+(1−0.01)*0.05=0.0595

Comp2_{—}Prod3=0.3565

Comp2_{—}Prod4=0.01

. . .

Comp2_{—}Prod100=0.01

Then the additional confidence obtained via Component_2 is summed and normalized.

Comp2_{—}Prod1=0.4112+(1−0.4112)*0.033=0.43

Comp2_{—}Prod2=0.0595+(1−0.0595)*0.033=0.0905

Comp2_{—}Prod3=0.3565+(1−0.3565)*0.033=0.378

Comp2_{—}Prod4=0.01

. . .

Comp2_{—}Prod100=0.01

After completion of the 3-pass algorithm, the confidence of component-product bundling is as follows:

Component_1:

Comp1_{—}Prod1=0.85

Comp1_{—}Prod2=0.5

Component_2:

Comp2_{—}Prod1=0.43

Comp2_{—}Prod2=0.0905

Comp2_{—}Prod3=0.378

Comp2_{—}Prod4=0.01

. . .

Comp2_{—}Prod100=0.01

Component_3:

Comp3_{—}Prod1=0.799

Comp3_{—}Prod2=0.33

Comp3_{—}Prod3=0.33

As is apparent from the above confidence values, Component_1, Component_2 and Component_3 are correctly recognized as most probably belonging to Product_1.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described with reference to flowchart illustrations and/or block diagrams of methods, apparatus (systems) and computer program products according to embodiments of the present disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The block diagrams in the Figures illustrate the architecture, functionality, and operation of possible implementations of systems, methods and computer program products according to various embodiments of the present disclosure. In this regard, each block in the block diagrams may represent a module, segment, or portion of code, which comprises one or more executable instructions for implementing the specified logical function(s). It should also be noted that, in some alternative implementations, the functions discussed hereinabove may occur out of the disclosed order. For example, two functions taught in succession may, in fact, be executed substantially concurrently, or the functions may sometimes be executed in the reverse order, depending upon the functionality involved. It will also be noted that each block of the block diagrams, and combinations of blocks in the block diagrams, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A method for identifying software components of a software product, comprising:
establishing, by a computer, representative data representative of at least one of an attribute and an action of at least one of a first software component in a computer system and a second software component in said computer system;
establishing a first confidence value indicative of a likelihood that said first software component belongs to said software product;
establishing, based on said data, a second confidence value indicative of a likelihood that said first software component and said second software component are software components of a common software product; and
establishing, based on said first and second confidence values, a third confidence value indicative of a likelihood that said second software component belongs to said software product.

2. The method of claim 1, wherein said representative data comprises indicative data indicative of at least one of a location of said first software component in said computer system, a location of said second software component in said computer system, an occurrence of communication in said computer system between said first and second software components, a configuration reference in said computer system between said first and second software components, an installation time of said first software component in said computer system, and an installation time of said second software component in said computer system.

3. The method of claim 1, further comprising establishing, for said second software component, a fourth confidence value indicative of a likelihood that said second software component belongs to said software product, wherein said establishing of said third confidence value is effected based on said first, second and fourth confidence values.

4. The method of claim 3, wherein said establishing of said fourth confidence value comprises at least one of:
establishing whether said second software component belongs to a predetermined catalog set of software components associated with said software product, and
establishing whether a product number associated with said second software component comprises a part number component indicative of a bundling of said first software component to said software product.

5. The method of claim 1, wherein said establishing of said first confidence value comprises at least one of:
establishing whether said first software component belongs to a predetermined catalog set of software components associated with said software product, and
establishing whether a product number associated with said first software component comprises a part number component indicative of a bundling of said first software component to said software product.

6. The method of claim 1, wherein said establishing of said second confidence value comprises at least one of:
increasing said second confidence value by a value indicative of full confidence that said first software component and said second software component are software components of a common software product if said representative data is indicative of an occurrence of communication in said computer system between said first and second software components;
increasing said second confidence value by a value indicative of full confidence that said first software component and said second software component are software components of a common software product if said representative data is indicative of a configuration reference in said computer system between said first and second software components;
increasing said second confidence value by a value indicative of partial confidence that said first software component and said second software component are software components of a common software product if said representative data is indicative of said first and second software components being located on a common host;
increasing said second confidence value by a value indicative of partial confidence that said first software component and said second software component are software components of a common software product if said representative data is indicative of installation paths of said first and second software components being nested; and
increasing said second confidence value by a value indicative of partial confidence that said first software component and said second software component are software components of a common software product if said representative data is indicative of said first and second software components having installation times falling within a predetermined period that is any one of less than one week, less than one day and less than one hour.

7. The method of claim 1, wherein said third confidence value is a product of said first confidence value and said second confidence value.
